(19) United States
(12) Patent Application Publication
(10) Pub. No.: US 2006/0145518 A1
(43) Pub. Date: Jul. 6, 2006

(54) Control system for a vehicle roof

(76) Inventors: Alan F. Evans JR., Rochester Hills, MI (US); James E. Tousignant, New Boston, MI (US); Arthur L. MacNee III, Southgate, MI (US)

Correspondence Address: HARNESS, DICKEY & PIERCE, P.L.C., P.O. BOX 828, BLOOMFIELD HILLS, MI, 48303, US

(21) Appl. No.: 11/029,073

(22) Filed: Jan. 4, 2005

(51) Int. Cl. B60J 7/057

(52) U.S. Cl. 296/223

(57) ABSTRACT

A control system is provided for closing a roof in an automotive vehicle. The control system is coupled to the roof and to a control device. A user-friendly switch is on the control device. The user-friendly switch moves in a same direction as a movement of the roof.

### BACKGROUND AND SUMMARY OF THE INVENTION

The present invention relates generally to a control system. More particularly, the present invention relates to a control system for a vehicle roof.

Vehicles with a movable portion of a roof are becoming increasingly popular. To reposition a moveable portion of a roof, a driver activates a control switch. One type of control switch is a push button that must be depressed while the moveable portion of the roof moves from a front to a rear position. To return the moveable portion back to its original position, the driver is required to continuously pull back on the control switch. This control switch configuration lacks intuitive features that easily inform the user as to the manner in which to open or close a portion of the roof. In accordance with the present invention, a control system is provided for closing a roof in an automotive vehicle. In another aspect of the present invention, the control system is coupled to the roof. In still yet another aspect of the present invention, the control system includes a control module and a control device. A further aspect of the present invention employs a user-friendly switch on the control device. In still yet another aspect of the present invention, the user-friendly switch moves in a same direction as a movement of the roof.

The control switch is advantageous since its appearance immediately indicates its purpose and its manner of operation. Additional advantages and features of the present invention will become apparent from the following description and appended claims, taken in conjunction with the accompanying drawings.

### BRIEF DESCRIPTION OF THE DRAWINGS

The present invention will become more fully understood from the detailed description and the accompanying drawings, wherein:

FIG. 1A is a perspective view of a closed roof on a vehicle of the present invention;

FIGS. 1B and 1C are block diagrams of control devices of the present invention;

FIG. 2A is a perspective view of a partially open roof near a front and rear panel on a vehicle of the present invention;

FIGS. 2B and 2C are block diagrams of control devices of the present invention;

FIG. 3A is a perspective view of a partially opened rear roof on a vehicle of the present invention;

FIGS. 3B and 3C are block diagrams of control devices of the present invention;

FIG. 4A is a perspective view of a partially opened front roof on a vehicle of the present invention;

FIGS. 4B and 4C are block diagrams of control devices of the present invention;

FIG. 5 is a schematic diagram of a control circuit of the present invention; and

FIG. 6 is a flow diagram illustrating a method of controlling a movement of a moveable portion of a roof to a vehicle.

### DETAILED DESCRIPTION OF THE PREFERRED EMBODIMENT

The following description of the preferred embodiment is merely exemplary in nature and is in no way intended to limit the invention, its application, or uses. For purposes of clarity, the same reference numbers are used in the drawings to identify similar elements. As used herein, the term “module” or “controller” refers to an application specific integrated circuit (ASIC), an electronic circuit, a processor (shared, dedicated, or group) and memory that execute one or more software or firmware programs, a combinational logic circuit, or other suitable components that provide the described functionality.

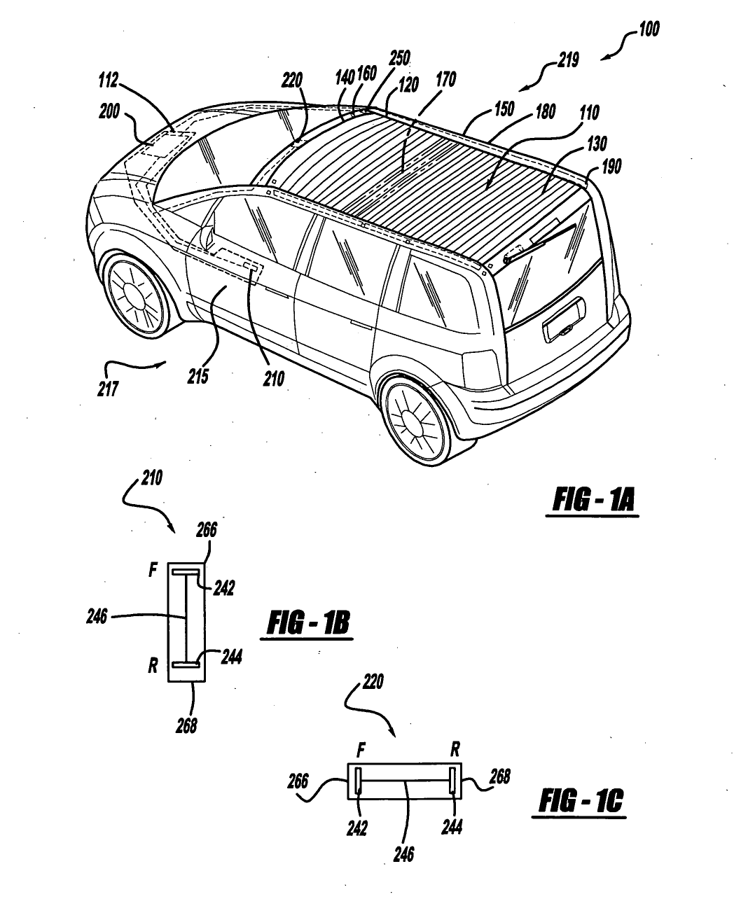

FIGS. 1-6 illustrate the preferred embodiments of a system to control a moveable portion of a roof. Vehicle 100 includes a roof 110 and a roof control system 112. Roof 110 comprises a front moveable portion 120 (also referred to as a first moveable portion) and a rear moveable portion 130 (also referred to as a second moveable portion). Front moveable portion 120 extends from a front position 140 disposed in a header 160 to a rear position 150 adjacent to an optional support member 170. In comparison, rear moveable portion 130 extends from a front position 180 adjacent to support member 170 to a rear position 190. First and second moveable portions 120, 130 may comprise cloth-like material, polymeric material, or the like.

Roof control system 112 controls the movement of front and/or rear moveable portions 120, 130. Roof control system 112 comprises a first control device 210, an optional second control device 220, a control module 200, and an actuation system 250. First and second control devices 210, 220, depicted in greater detail in FIGS. 1B and 1C, include front slide potentiometer 242 (also referred to as a first switch) and rear slide potentiometer 244 (also referred to as a second switch) that move along path 246. Front slide potentiometer 242 is a switch connected to control module 200. Front slide potentiometer 242 is turned to an “on” state when it moves along path 246. This causes front slide potentiometer 242 to signal control module 200. Control module 200 then signals an actuation system 250 to move front moveable portion 120. An example of actuation system 250 may be seen with respect to U.S. Pat. No. 5,169,206 issued Dec. 8, 1992, and assigned to the assignee of the present invention, the disclosure of which is incorporated by reference in its entirety herein. Rear slide potentiometer 244 is another switch connected to control module 200. Moving rear slide potentiometer 244 along path 246 causes a signal to be transmitted from the rear slide potentiometer 244 to control module 200. Control module 200 then signals actuation system 250 to move rear moveable portion 130.

FIGS. 1A-1C through FIGS. 4A-4C illustrate user-friendly features of control devices 210, 220. First control device 210 is oriented such that front side potentiometer 242 directly corresponds to the movement of front moveable portion 120 and rear slide potentiometer 244 directly corresponds to the movement of rear moveable portion 130. This is achieved, in part, by having front slide potentiometer 242 point toward the front and rear slide potentiometer 244 point toward the rear of vehicle 100. In contrast, second control device 220 is oriented in vehicle 100 such that front slide potentiometer 242 points toward door 215 on the driver's side 217 and rear slide potentiometer 244 points toward a diametrically opposing side 219.

When front slide potentiometer 242 is moved along path 246 from a front position 266 to a rear position, front moveable portion 120 correspondingly moves from a front to a rear position. For example, FIG. 1A illustrates front and rear moveable portions 120, 130 are in closed positions. FIGS. 1B-1C depict front slide potentiometer 242 in a front position 266. This position corresponds to front moveable portion 120 in a closed position. Rear slide potentiometer 244 is located near rear position 268, which represents the closed position for rear moveable portion 130.

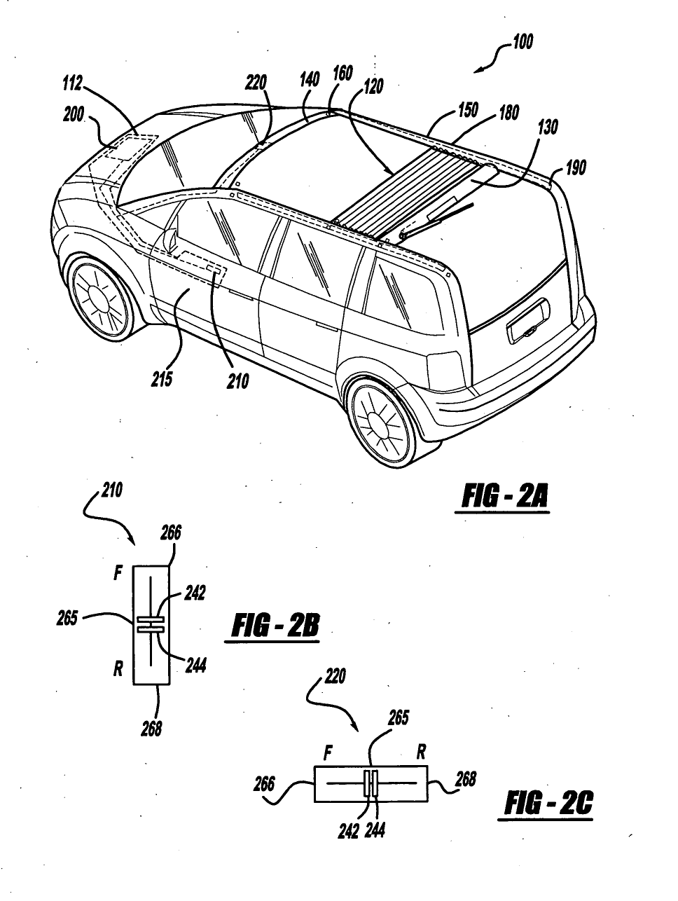

FIG. 2A illustrates front moveable portion 120 moved toward center position 180 thereby fully opening the area of the roof where front moveable portion 120 was previously located. FIGS. 2B-2C depict front slide potentiometer 242 slid to a corresponding center position 265, which represents the open position for front moveable portion 120. Similarly, rear moveable portion 120 is partially open. Therefore, rear slide potentiometer 244 is slid to a partially open position near center position 265.

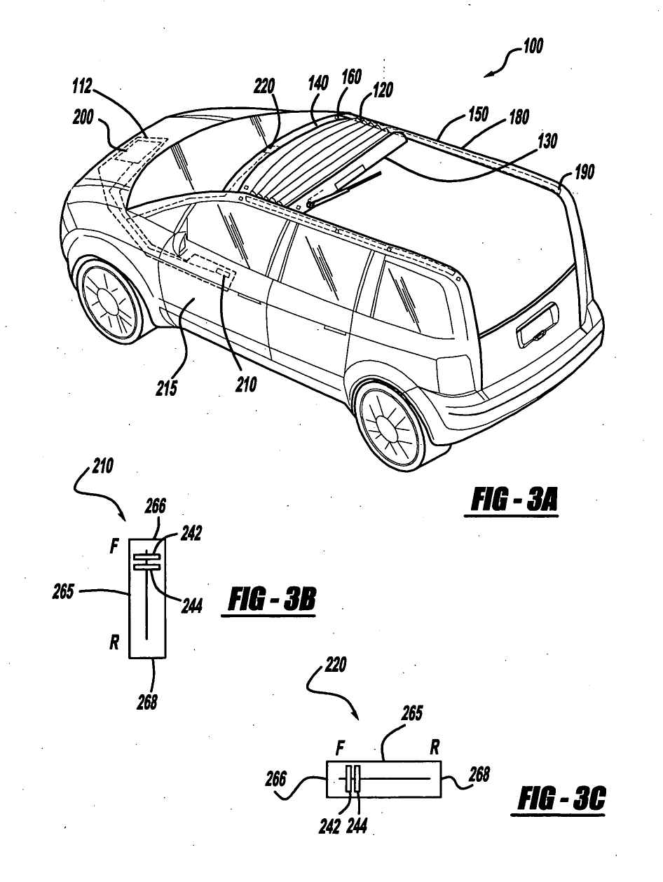

FIG. 3A illustrates front moveable portion 120 in a closed position and rear moveable portion 130 in a fully open position. FIGS. 3B-3C depict front slide potentiometer 242 slid to front position 266, which corresponds with the closed position of front moveable portion 120. Since rear moveable portion 130 is fully open, rear slide potentiometer 244 is slid to front position 266.

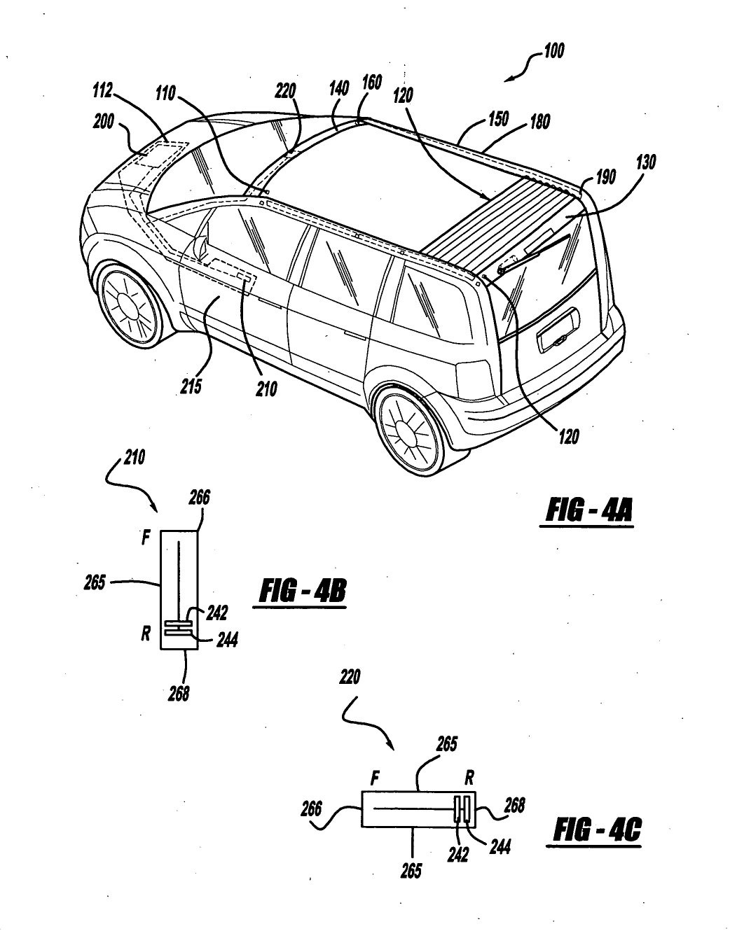

FIG. 4A illustrates front moveable portion 120 in an open position and rear moveable portion 130 in a closed position. FIGS. 4B-4C depict front slide potentiometer 242 slid to front position 266, which represents the closed position for front moveable portion 120. Since rear moveable portion 130 is closed, rear slide potentiometer 244 is slid near rear position 268.

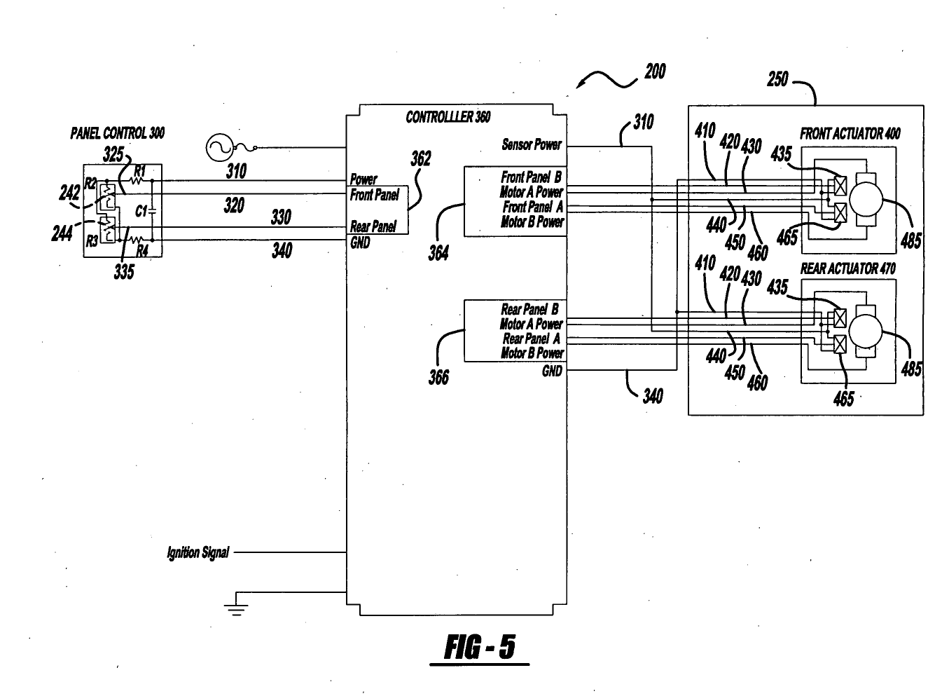

FIG. 5 depicts details of control module 200, which controls the movement of front and rear moveable portions 120, 130 of roof 110 through signaling actuation system 250. Control module 200 comprises a panel control 300 and a controller 360. Panel control 300 includes front slide potentiometer 242, rear slide potentiometer 244, resistors R1, R4, wipers 325, 335 and optional capacitor C1. Front slide potentiometer 242 includes resistor R2, which is directly connected to resistors R1, R3, R4 and to wiper 325. Wiper 325 connects front slide potentiometer 242 to the front panel input for controller 360.

Wiper 325 samples the voltage of front slide potentiometer 242 after wiper 325 moves across resistor R2. The direction that wiper 325 moves depends upon the voltage across resistor R2. For example, resistors R1 and R4 bias wiper 325 up off the rails when the voltage across resistor R2 is high (e.g. 4.5 volts). A higher voltage across R2 indicates that the operator desires front moveable portion 120 to move from a rear to a front position. In contrast, resistors R1 and R4 bias wiper 325 down off the rails when the voltage across resistor R2 is low (e.g. 0.5 volts). A lower voltage across resistor R2 indicates that the front moveable portion 120 must move from a front to a rear position.

Rear slide potentiometer 244 includes resistor R3, which is connected to resistors R1, R2, R4 and to wiper 335. Wiper 335 samples the voltage across resistor R3. Resistors R1 and R4 bias wiper 335 up off the rails when the voltage across resistor R3 is high (e.g. 4.5 volts). A higher voltage across resistor R3 indicates that the rear moveable portion 130 moves from a rear to a front position. In contrast, R1 and R4 bias wiper 335 down off the rails when the voltage across resistor R3 is low (e.g. 0.5 volts). A lower voltage across resistor R3 indicates that rear moveable portion 130 moves from a front to a rear position.

Controller 360 includes an operator input control 362, a front panel control 364, and a rear panel control 366. Operator input control 362 includes inputs for front and rear slide potentiometers 244, 246 from panel control 300, as previously described. Front panel control 364 has a front panel A and B output connected to front actuator 400 via conductive lines 450, 420 respectively. Front panel control 364 also includes motor power inputs via conductive lines 430, 460 from a front actuator 400. Current and position data of motor 485 is also transmitted over conductive lines 430, 460. Rear panel control 364 has a similar configuration and operation as front panel control 364.

An actuation system 250 comprises front actuator 400 and a rear actuator 470. Front actuator 400 moves front moveable portion 120. Front actuator 400 includes two front panel sensors 435, 465 and motor 485. Front panel sensors 435, 465 indicate to controller 360 the relative position of front moveable portion 120. Front panel sensors 435, 465 may be Hall effect sensors (“Hall sensors”) or other like position indicating sensors. Front panel sensors receive power over conductive line 310. After controller 360 has determined the position of front moveable portion 120 and the operator's desired position for advancing and retracting the front moveable portion 120, controller 360 signals motor 485 via conductive line 430 or conductive line 450 to drive a gear head (not shown), which in turn drives the cabling (not shown) for front moveable portion 120. This causes front moveable portion 120 to move. One skilled in the art will recognize that rear panel control 366 operates in a manner similar to front panel control 364.

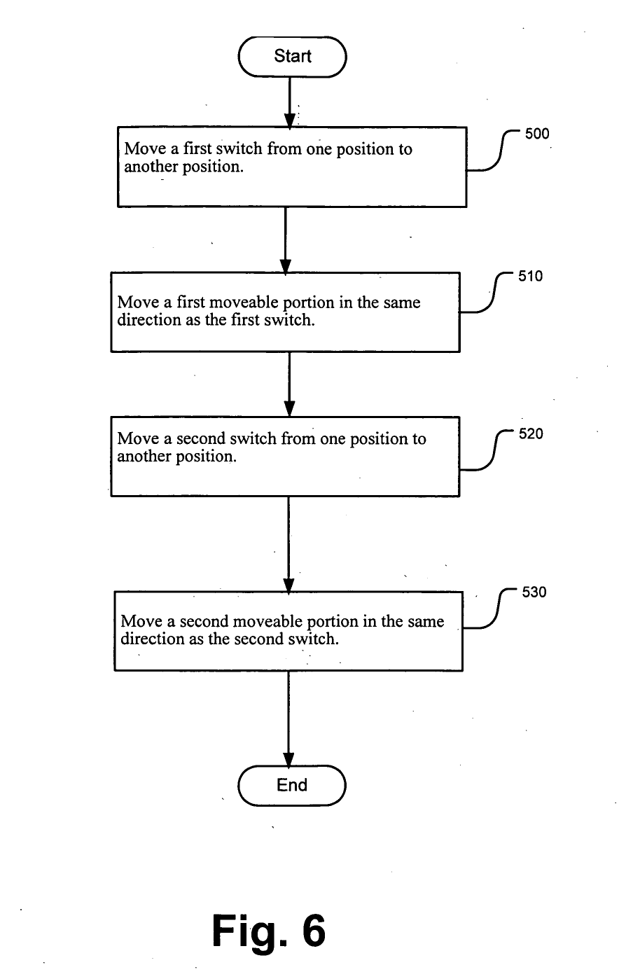

FIG. 6 is a flow diagram of a method for controlling a first moveable portion and/or a second moveable portion of a vehicle roof. At operation 500, a first switch is moved from a first position to a second position. This causes first moveable portion to move in a same a direction as the first switch, at operation 510. At operation 520, a second switch is moved from a third position to a fourth position. At operation 530, a second moveable portion is moved in a same a direction as the second switch.

While the preferred embodiment of the control system has been disclosed, various alterations can be made which fall within the scope of the present invention. The present invention has numerous applications. For example, the front moveable portion may be completely separate from rear moveable portion. Additionally, the moveable portions may also be configured to move sideways. Roof control system 112 controls the movement of these two separate moveable portions. Moreover, the system to control the moveable portion of the roof may be configured in a variety of ways, as shown by each of the U.S. patents listed below which are incorporated by reference: U.S. Pat. No. 3,960,404 issued on Jun. 1, 1976 to Bienert, entitled “Sliding Roof Structure with Two-Way Openable Roof Panel”; U.S. Pat. No. 3,702,430 issued on Nov. 7, 1972 to Knetsch, entitled “Control Device for Electromechanically Operated Closure Panels”; U.S. Pat. No. 4,502,726 issued on Mar. 5, 1985 to Adams entitled, “Control Apparatus for Pivotal Sliding Roof Panel Assembly”; U.S. Pat. No. 4,561,691 issued on Dec. 31, 1985, entitled “Safety Device for Electromechanical Opening and Closing Mechanism”; U.S. Pat. No. 4,329,594 issued on May 11, 1982, entitled “Pivotal and Slidable Auto Roof Cover”; U.S. Pat. No. 5,242,210 issued Sep. 7, 1993, entitled “Control Apparatus for Opening or Closing Roof of a Vehicle”; and U.S. Pat. No. 4,733,145 issued Mar. 22, 1988, entitled “Drive Control System for Vehicle Mounted, Electrically Driven Devices”.

It will be appreciated that more or fewer processes may be incorporated into the methods described herein without departing from the scope of the invention and that no particular order is implied by the arrangement of blocks shown and described herein. Skilled artisans appreciate that the method described herein may be embodied in machine-executable instructions or statements (for example, programmable computer software). The instructions can be used to cause a general-purpose or special-purpose processor that is programmed with the instructions to perform the operations described. Alternatively, the operations may be performed by specific hardware components that contain hard-wired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” includes any medium that is capable of storing or encoding a sequence of instructions for execution by the machine and that cause the machine to perform any one of the methodologies of the present invention. The term “machine-readable medium” includes, but is not be limited to, solid-state memories, optical and magnetic disks, and carrier wave signals. Furthermore, it is common in the art to speak of software, in one form or another (e.g., program, procedure, process, application, module, logic, statement etc.), as taking an action or causing a result. Such expressions are merely a shorthand way of stating that the execution of the software by a computer causes the processor of the computer to perform an action or to produce a result.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An automotive vehicle system comprising:
a moveable roof;
an actuation system coupled to the moveable roof;
a control module coupled to the actuation system; and
a control device coupled to the control module, the control device operably controls movement of the moveable roof through a first switch, the moveable roof operably moving in a same direction as a movement of the first switch.

2. The automotive system of claim 1, wherein the first switch moves from a first front position to a first rear position, which causes the moveable roof to correspondingly move from a second front position to a second rear position.

3. The automotive system of claim 1, wherein the first switch moves from a first rear position to a first front position, which causes the moveable roof to move from a second rear position to a second front position.

4. The automotive system of claim 1, wherein the moveable roof further includes a front moveable portion and a rear moveable portion, wherein the control device includes a second switch, the first switch operably moves the front moveable portion and the second switch operably moves the rear moveable portion.

5. The automotive system of claim 4, wherein the front moveable portion moves from a first front position to a first rear position and a rear moveable portion of the automotive roof moves from a second rear position to a second front position.

6. A system for an automotive vehicle, the system comprising:
a vehicle roof which includes a front moveable portion and a rear moveable portion;
a control module connected to the vehicle roof; and
a control device coupled to the control module, the control device comprises a front switch and a rear switch, the front switch corresponds with the front moveable portion and the rear switch corresponds with the rear moveable portion,
wherein the control device orientation in the vehicle allows the front switch to correspondingly move the front moveable portion in a first same direction and the rear switch correspondingly moves the rear moveable portion in a second same direction.

7. The system of claim 6, wherein the first same direction occurs from front to rear.

8. The system of claim 6, wherein the first same direction occurs from rear to front.

9. The system of claim 6, wherein the second same direction occurs from front to rear.

10. The system of claim 6, wherein the second same direction occurs from rear to front.

11. An apparatus comprising:
a first roof portion;
a second roof portion;
a first switch;
a second switch;
memory including instructions further comprising:
a first set of instructions operably moving the first roof portion from a first position to a second position in a same direction as the first switch; and
a second set of instructions operably moving the second roof portion from a third position to a fourth position in a same direction as the second switch.

12. The apparatus of claim 11, wherein the first position is a front position and the second position is a rear position.

13. The apparatus of claim 11, wherein the first position is a rear position and the second position is a front position.

14. The apparatus of claim 11, wherein the third position is a front position and the fourth position is a rear position.

15. The apparatus of claim 11, wherein the third position is a rear position and the fourth position is a front position.

16. A control device for controlling a first moveable portion and a second moveable portion of a vehicle roof, the control device comprising:
a first switch coupled to the first moveable portion, the first moveable portion operably moves in a same direction as the first switch; and
a second switch coupled to the second moveable portion, the second moveable portion operably moves in a same direction as the second switch.

17. The control device of claim 16, wherein the first switch moves from a first front position to a first rear position, which causes the first moveable portion to move from a second front position to a second rear position.

18. The control device of claim 16, wherein the second switch moves from a first front position to a first rear position, which causes the second moveable portion to move from a second front position to a second rear position.

19. The control device of claim 16, wherein the first moveable portion is a front moveable portion and second moveable portion is a rear moveable portion.

20. The control device of claim 16, wherein the moveable portion comprises the vehicle roof, which extends a length from a front header to a rear header.

21. An automotive vehicle system comprising:
a front moveable portion;
a rear moveable portion;
a first switch associated with the front moveable portion;
a second switch associated with the rear moveable portion;
an actuation system coupled to the front and rear moveable portions;
a control module coupled to the first switch and the second switch, the control module operable to signal the actuation system to move the front moveable portion in a same direction as a first switch; and
the control module operable to signal the actuation system to move the second moveable portion in a same direction as a second switch.

22. The automotive vehicle system of claim 21, wherein the first switch moves from a front position to a rear position, which causes the front moveable portion to move from a second front position to a second rear position.

23. The automotive vehicle system of claim 21, wherein the second switch moves from a front position to a rear position, which causes the rear moveable portion to move from a second front position to a second rear position.

24. The automotive vehicle system of claim 21 further comprising:
a first sensing system coupled to the control module, the sensing system determines a location of the front moveable portion.

25. The automotive vehicle system of claim 21 further comprising:
a second sensing system coupled to the control module, the sensing system determines a location of the second moveable portion.

26. A method for controlling a first moveable roof portion and a second moveable roof portion of a vehicle roof with a first switch and a second switch, the method comprising:
moving the first switch from a first position to a second position;
moving the first moveable portion in a same direction as the first switch;
moving the second switch from a third position to a fourth position; and
moving the second moveable portion in a same direction as the second switch.

27. The method of claim 26, wherein the first position is a front position and the second position is a rear position.

28. The method of claim 26, wherein the first position is a rear position and the second position is a front position.

29. The method of claim 26, wherein the third position is a front position and the fourth position is a rear position.

30. The method of claim 26, wherein the third position is a rear position and the fourth position is a front position.

31. The method of claim 26, wherein the first switch is a front slide potentiometer.

32. The method of claim 26, wherein the second switch is a rear slide potentiometer.
